(19) United States
(12) Patent Application Publication
(10) Pub. No.: US 2024/0293793 A1
(43) Pub. Date: Sep. 5, 2024

(54) MATERIAL FOR NEUTRALISING AND/OR HARDENING LIQUIDS, A METHOD FOR PRODUCING SAME, AND USES

(71) Applicant: Rheinkalk GmbH, Wülfrath (DE)

(72) Inventor: Uwe FISCHER, Leverkusen (DE)

(21) Appl. No.: 18/598,281

(22) Filed: Mar. 7, 2024

Related U.S. Application Data
(62) Division of application No. 15/559,197, filed on Jan. 31, 2018, now abandoned.

(30) Foreign Application Priority Data
Mar. 19, 2015 (DE) 102015003475.8

(51) Int. Cl. B01J 20/04; B01J 20/28; B01J 20/30; C02F 1/66; C02F 5/06; C02F 101/20

(52) U.S. Cl. CPC B01J 20/043; B01J 20/041; B01J 20/28011; B01J 20/28019; B01J 20/2803; B01J 20/28059; B01J 20/3028; B01J 20/3085; C02F 1/66; C02F 5/06; C02F 2101/203; C02F 2101/206

(57) ABSTRACT

The invention relates to a material comprising at least 97% by weight alkaline earth metal carbonates having a calcium oxide content of 0.3% by weight or less and a particle size group of 0.1 to 1.8 mm. The invention furthermore relates to a method for the preparation thereof and also the use thereof for deacidification, filtration and/or hardening of liquids.

The invention relates to a material for deacidification, filtration and/or hardening of liquids with a proportion by mass of alkaline earth metal carbonate of >97%.

For the deacidification of liquids, particularly water, by filtration, a wide variety of different materials are used. Deacidification refers to the removal of aggressive carbonic acid from liquids. The adjustment of the lime-carbonic acid equilibrium is in particular important for drinking and raw waters. Waters with higher contents of carbonic acid than that which corresponds to equilibrium are particularly corrosive to some materials. For example, unprotected systems composed of iron material are corroded. Natural waters are often not in lime-carbonic acid equilibrium. When mixing waters, a mixed water problem frequently occurs due to aggressive carbonic acid. Processing of these aggressive waters is necessary.

Materials based on calcium carbonate (CaCO3) have proven to be suitable filter materials. These materials are typically used as a filter layer in open or closed filtration plants. By reacting with the carbonic acid present in the water, the water to be treated is neutralized by filtration.

For neutralizing and filtering spring water, well water and surface water, particularly reservoir water, the filter material must meet particular requirements of purity for reasons of health protection.

The requirements are set out, for example, in standard DIN 2000, the drinking water directive and the German regulation on the use of additives. Further fields of application are the deacidification and, if required, filtration, deacidification and filtration of filling water for swimming pools and bathing pools, filtration and pH stabilization in the processing of swimming pool and bathing pool water and also hardening of distillate and permeate for use as drinking water.

A further field of application is the deferrization and demanganization of waters, i.e. the removal of divalent compounds of iron and manganese. For this purpose, water treatment plants generally have an aeration device. While surface water generally contains no or only small amounts of these metal compounds, higher amounts of iron (II) and manganese (II) compounds can be found in groundwater. In high amounts these compounds can be toxic so that they have to be removed from the waters. Low contents of iron (II) and manganese (II) compounds however are not toxic per se. However, they form sparingly soluble reddish brown to black oxide hydrates in the presence of oxygen. For this reason, they must also be removed from the waters before use.

According to legal requirements, drinking water must not contain any or only very small amounts of iron (II) and manganese (II) compounds. The threshold values for drinking water are 0.2 mg/dm³ for iron and 0.05 mg/dm³ for manganese. For drinking water in Germany, the legal requirements of the German drinking water regulation (standard DIN 2000) must be met. In addition to drinking water, raw water is also usually processed before use so that it is free from higher contents of these compounds.

For use in filter systems, a stable grain structure of the material is also required for safe, low-maintenance and economically viable operation. It is known, for example, to use crystalline calcium carbonate from Devonian deposits or Jurassic deposits as split material in various grain classes.

The aggressive carbonic acid is chemically bound with crystalline calcium carbonate according to the following equation:

CO₂+CaCO₃+H₂O→Ca(HCO₃)₂

The advantage of this approach is that overreactions can be avoided. Even in the case of new filter fillings, excessive binding is not possible. However, a disadvantage of this type of deacidification is that a long contact time is necessary for the binding of the aggressive carbonic acid to reach equilibrium. This requires large filling amounts and thus large filter systems. The application is therefore limited to plants for relatively small amounts of water. A further disadvantage is that in the case of split-crystal grain, the reactivity is reduced because of the smooth crystal surfaces. For the deacidification, extended contact times must therefore be considered. In addition, the limestone granules have an undesirable dust content.

To improve the chemical reactivity, calcium carbonate with a proportion of magnesium oxide as a porous filter material is also used. It serves to deacidify carbonate aggressive waters by filtration. Due to its high reactivity, the specific usage is particularly favourable. They are used, inter alia, in rapid filter systems for drinking water production. When using this material in filter systems, problems may occur due to caking of the grains caused by over-alkalinity of the water.

It has also been attempted to use other limes in a suitable grain size for deacidification and filtration of water, for example coral limestone. However, due to the impurities contained therein, there is the danger that the filter bed is contaminated microbiologically, so that hygienic problems with the drinking water occur. This could be remedied by thermal treatment of these limes (dead burning) but which is associated with high costs.

DE 195 03 913 A1 describes a process for deacidification and filtration of water with a granular chemically reacting filter material with a proportion by mass of alkaline earth metal carbonate of >97%, in which a material obtained by recarbonating granules of alkaline earth metal carbonate, alkaline earth metal hydroxide and water is used as the filter material.

The filter material described already affords very good results in the deacidification and filtration of water. For instance, it has a high degree of purity in a stable grain structure and does not form dust. Furthermore, it can thereby be prevented that foreign substances get into the water through the filter material, and it can be ensured that, even after the treatment, only substances which naturally occur in the water are present.

However, a disadvantage of this filter material has proven to be that, with new filter masses, it can lead initially for a period of time to over-alkalization during the start-up phase. For instance, depending on the equilibrium position, the pH can increase, for example, by about 0.5. This can be prevented by introducing the filter material in a batchwise manner. However, this extends the start-up period.

A further disadvantage of this filter material is that it can only be used to a limited extent for the processing of liquids containing iron and manganese. The deposition of relatively large amounts of these compounds can lead to a partial blockage of the grain surface, which hinders deacidification.

The object of the invention is to provide a filter material with which the disadvantages described above can be avoided. In particular, even in the case of novel filter masses, it should be possible to avoid over-alkalization during the start-up phase. In addition, the filter material should also be suitable for filtering liquids with relatively high iron and manganese contents.

This object is achieved according to the invention by providing a material comprising at least 97% by weight alkaline earth metal carbonate, wherein the calcium oxide content of the material is 0.3% by weight or less and the particle size group of the material is from 0.1 to 1.8 mm.

The content of alkaline earth metal carbonate and the calcium oxide content are in each case based on the total weight of the material.

The particle size group can, for example, be defined as described in standard DIN EN 12901, in particular in the standard DIN EN 12901: 2000-1. Those skilled in the art understand particle size group to mean all the particle sizes of a material which are between two sieve widths. Examples of sieve widths are listed in standard DIN ISO 3310-1, in particular in the standard DIN ISO 3310-1: 2001-09. The sieve widths are also referred to as the nominal mesh width. However, other sieve widths are also conceivable, for example the sieve widths which delimit a particle size group can also be theoretical sieve widths. The particle size group can be specified, for example, in the form of 0.1 mm to 1.8 mm or in the form of 0.1/1.8 mm. The particle size group can be determined in accordance with standard DIN EN 12902, in particular in accordance with standard DIN EN 12902: 2005-02. In particular, the particle size group can be determined by determining a particle size distribution. For example, from a particle size distribution, two particle sizes can be selected as sieve widths between which the particle size group is located. A particle size distribution can be determined in accordance with standard DIN EN 12902, in particular in accordance with standard DIN EN 12902: 2005-02. The particle size distribution can be determined by sieving, in particular in accordance with standard ISO 2591-1, in particular in accordance with standard ISO 2591-1:1988. The sieves used for this purpose are also referred to as test sieves and have different sieve widths or nominal widths. For pulverulent materials, the particle size distribution may also be determined using a laser diffractometer. This can be conducted in accordance with standard ISO 13320-1, in particular in accordance with standard ISO 13320:2009. According to the methods cited, the undersize fraction of the particle size group, i.e. the proportion by mass in % by weight of a granular material which passes through the sieve with the smallest sieve width for the particular particle size group, can also be determined. Likewise, according to the methods described, the oversize fraction, i.e. the proportion by mass in % by weight of a particle mixture which is retained by the sieve with the largest sieve width for the particular particle size group, can be determined.

According to a preferred embodiment of the material, the oversized and undersized content of a fixed particle size group of the material is 10% by weight or less, based on the total weight of the material with this particle size group.

It has been found, surprisingly, that when using the material according to the invention, it is possible to avoid the disadvantages from the prior art discussed above. For instance, when using the material, even in the case of novel filtermasses, over-alkalization during the start-up phase can be avoided. Therefore, in the case of the material according to the invention, it is no longer necessary to carry out the filling of the processing plants in a stepwise manner. Instead, the pH increases only marginally during the filling. As a result, the start-up period can be significantly reduced. The material according to the invention is therefore suitable even for the processing of soft waters and for use in small plants.

It is assumed that this effect is due in particular to the low calcium oxide content in the material according to the invention. In accordance with the invention, this content is 0.3% by weight or less, preferably from 0.2 to 0.01% by weight and especially from 0.1 to 0.01% by weight. This low calcium oxide content can be obtained, for example, by the fact that the production of the material comprises a two-fold recarbonation combined with a sieving to a particle size group of 0.1 to 1.8 mm.

“Calcium oxide content” is particularly understood to mean the free calcium oxide content. The calcium oxide content in the material can be determined by the measurement methods known to those skilled in the art, for example by conductivity. The calcium oxide content in the material can also be determined according to standard DIN EN 12485, in particular according to standard DIN EN 12485: 2010-08, which are to be applied accordingly in each case.

It has been found, surprisingly, that it is possible to still further reduce the calcium oxide content in the material, which is reduced by a first recarbonation, when this first recarbonation step is followed by a sieving to a particle size group of 0.1 to 1.8 mm followed by a second recarbonation step. As a result, the calcium oxide content in the material can be reduced to less than 0.3% by weight.

A material with a particle size group of 0.1 to 1.8 mm can be obtained by sieving. According to a preferred embodiment of the invention, the material has a particle size group of 0.2 to 1.7 mm, more preferably 0.5 to 1.6 mm. According to a further preferred embodiment, the material has a particle size group of 0.71 to 1.25 mm.

A further advantage of the two-fold recarbonation is that a more stable filter operation is made possible with the material obtained thereby.

According to a further preferred embodiment of the material, the material comprises at least 98% by weight alkaline earth metal carbonate. According to a further preferred embodiment of the material, the material comprises at least 99% by weight alkaline earth metal carbonate.

According to a preferred embodiment of the invention, the alkaline earth metal carbonate present in the material comprises calcium carbonate and/or magnesium carbonate.

According to a further preferred embodiment of the invention, the alkaline earth metal carbonate present in the material comprises a mixture of calcium carbonate and magnesium carbonate.

Preferably, the alkaline earth metal carbonate present in the material comprises at least 90% by weight, preferably at least 95% by weight, more preferably at least 97% by weight, even more preferably at least 98% by weight, even more preferably at least 99% % by weight calcium carbonate, based on the total amount of alkaline earth metal carbonate. In particular, the alkaline earth metal carbonate present in the material comprises from 97 to 99.9% by weight, more preferably from 98 to 99% by weight, calcium carbonate, based on the total amount of alkaline earth metal carbonate.

In particular, the alkaline earth metal carbonate present in the material may comprise magnesium carbonate in an amount of 0.01% by weight to 10% by weight, preferably 0.1% by weight to 5% by weight, more preferably 0.2% by weight to 2% by weight, based on the total amount of alkaline earth metal carbonate.

The requirements for filter materials for drinking water can be met with a material comprising calcium carbonate and/or magnesium carbonate. Furthermore, a particularly effective material can be obtained by using the stated amounts of calcium carbonate and/or magnesium carbonate.

In a preferred embodiment, the material is in the form of granules. This allows a particularly simple and dust-free handling, especially when filling the filter systems.

Practical experiments have shown that a particularly efficient utilization of the deacidification capacity of the constituents present in the material can be achieved with the material according to the invention. For instance, in comparison to the filter materials known from DE 195 03 913 A1, 10% to 20%, in some cases more than 20%, better consumption values were achieved. The actual consumption thus corresponds almost to the calculated value.

It is assumed that the high capacity of the material is at least partly due to the sieving to a particle size group of 0.1 to 1.8 mm. This results in the effective particle size being about 30 to 40 percent less than in the filter materials described in DE 195 03 913 A1. The effective particle size is for example, described in standard DIN EN 12901, in particular in standard DIN EN 12901: 2000-1. Accordingly, those skilled in the art understand the effective particle size to be the theoretical sieve width at which 10% by weight of the proportion by mass of the sample passes through the sieve. The effective particle size can be determined, for example, in accordance with standard DIN EN 12902, in particular in accordance with standard DIN EN 12902: 2005-02. In particular, the effective particle size can be determined by determining a particle size distribution.

A further advantage of the low effective particle size of the material according to the invention is that it enables a more effective filtration. As a result, the material can also be used for the treatment of liquids which contain constituents that are difficult to remove, such as liquids comprising iron and/or manganese, preferably water comprising iron and/or manganese. The material according to the invention is also particularly suitable for treating liquids, particularly water, having iron contents of more than 0.2 mg/dm³, preferably from 1 to 2 mg/dm³ and/or having manganese contents of more than 0.05 mg/dm³, preferably from 0.2 to 0.4 mg/dm³.

In addition, it was discovered that the use of the material according to the invention surprisingly can reduce cloudiness of the treated liquids compared to materials from the prior art.

As a measure of the cloudiness of liquids, the nephelometric turbidity unit (NTU) can be used in the water processing. It is the unit of turbidity of a liquid measured with a calibrated nephelometer. Practical experiments have shown that the NTU value can be improved by approximately 20% to 40% using the material according to the invention compared to the materials known from DE 195 03 913 A1. The NTU value can be measured, for example, according to standard DIN EN ISO 7027 (C2) 2000-4. The measurement method for FNU values and/or FAU values given in this standard can also be used in the same way for the determination of NTU values relative to formazine.

Low turbidity of the treated liquids is advantageous for their qualification, for example, as drinking water. The reason for this is, inter alia, the fact that microbiologically active compounds can adhere to free particles, which can have a negative influence on the biological water quality.

It was not foreseeable that an improvement in the cloudiness values can be achieved using the material according to the invention.

In accordance with a preferred embodiment of the invention, substantially alkaline earth metal carbonate, alkaline earth metal hydroxide and/or alkaline earth metal oxide can be used as starting materials for the production of the material. According to one embodiment of the invention, substantially alkaline earth metal carbonate and alkaline earth metal hydroxide are used as starting materials for the production of the material. Alternatively, an alkaline earth metal oxide or a mixture of alkaline earth metal hydroxide and alkaline earth metal oxide may be used instead of alkaline earth metal hydroxide. Preference is given to using limestone powder and/or hydrated lime, in particular white hydrated lime, as starting materials. Furthermore, a liquid, preferably water, can be used for the production of the material.

According to a further preferred embodiment of the invention, the alkaline earth metal carbonate used as starting material comprises at least 90% by weight, preferably at least 95% by weight, in particular from 97 to 99% by weight, more preferably from 98 to 99% by weight calcium carbonate. According to a further preferred embodiment, the alkaline earth metal hydroxide used as starting material comprises at least 90% by weight, preferably from 92 to 99% by weight, calcium hydroxide. Preferably, the alkaline earth metal oxide used as starting material comprises at least 90% by weight, preferably 92 to 99% by weight, calcium oxide.

The use of pure starting materials has the advantage that a material having a high degree of purity can thereby be obtained. Such a material is thus particularly suitable for obtaining and/or processing of drinking water.

According to a preferred embodiment of the invention, the material has a largely spherical particle morphology. According to a further preferred embodiment, the material has a spherical particle morphology. Such particle morphologies permit the formation of dense spherical packings. This is advantageous, for example, when using the material as a filter material, since it allows particularly fine filtering. Furthermore, a high packing density is advantageous due to the smaller packing volume for transport and storage of the material. Thus, the material according to the invention is also suitable, for example, for filters which are provided with suburban silos and which are delivered by silo vehicles.

Due to its high packing density, the material can also have a high bulk density of, for example, 1.1 to 1.3 g/cm³.

The material according to the invention preferably has a high specific surface area. In particular, the material according to the invention may have a specific surface area, in particular a BET surface area, for example, of at least 3.5 m²/g, preferably of 3.5 to 5.5 m²/g and especially of 4 to 5 m²/g. The specific surface area can, for example, be determined by the BET method according to standard ISO 9277, in particular according to standard ISO 9277: 2010. As a result, the material has a high activity. Moreover, particularly good filtration performance can be achieved in the filtration.

Overall, it is found that the material according to the invention has all the essential properties which make it a simple and at the same time reactive filter material in the application. Thus, the advantages of a simple application such as dense compact limestone provides are combined with the high reactivity of a porous filter material.

The present invention further provides a method for producing the material according to the invention comprising the following steps:
a) granulating a mixture comprising alkaline earth metal carbonate, alkaline earth metal hydroxide and/or alkaline earth metal oxide to give a granulate;
b) recarbonating the granulate by bringing into contact with a gas containing carbon dioxide;
c) sieving to a particle size group of 0.1 to 1.8 mm;
d) once again recarbonating the granulate by bringing into contact with a gas containing carbon dioxide.

Steps a) to d) are advantageously carried out successively.

The granulation in step a) is preferably carried out in the presence of a liquid, in particular water. Advantageously, the granulation in step a) is carried out in the presence of 1 to 50% by weight, in particular 5 to 20% by weight water, based on the total amount of alkaline earth metal carbonate, alkaline earth metal hydroxide and/or alkaline earth metal oxide.

The meaning of the particle size group, its determination and the oversize and undersize particles for a fixed particle size group described for material according to the invention above likewise apply to the method according to the invention

In a preferred embodiment of the invention, the mixture to be granulated in step a) comprises at least 90% by weight, preferably at least 95% by weight, more preferably at least 99% by weight alkaline earth metal carbonate, alkaline earth metal hydroxide and/or alkaline earth metal oxide.

According to a preferred embodiment of the method, the mixture to be granulated in step a) comprises at least 90% by weight, preferably at least 95% by weight, more preferably at least 99% by weight calcium carbonate, calcium hydroxide and/or calcium oxide.

According to a further preferred embodiment of the method, the mixture to be granulated in step a) comprises at least 90% by weight, preferably at least 95% by weight, more preferably at least 99% by weight limestone powder, hydrated lime and/or fine white lime. White hydrated lime in particular may be used as hydrated lime.

According to a further preferred embodiment of the method, the mixture to be granulated in step a) comprises at least 90% by weight, preferably at least 95% by weight, more preferably at least 99% by weight alkaline earth metal carbonate and alkaline earth metal hydroxide.

According to a further preferred embodiment of the method, the mixture to be granulated in step a) comprises at least 90% by weight, preferably at least 95% by weight, more preferably at least 99% by weight calcium carbonate and calcium hydroxide.

According to a further preferred embodiment of the method, the mixture to be granulated in step a) comprises at least 90% by weight, preferably at least 95% by weight, more preferably at least 99% by weight limestone powder and hydrated lime. White hydrated lime in particular may be used as hydrated lime.

In this case, a material with a high purity can be obtained which is particularly suitable for obtaining and/or processing drinking water.

According to a further preferred embodiment of the method, the mixture to be granulated in step a) comprises at least 40% by weight, preferably at least 50% by weight, more preferably at least 55% by weight alkaline earth metal carbonate, based on the total amount of alkaline earth metal carbonate and alkaline earth metal hydroxide.

According to a further preferred embodiment of the method, the mixture to be granulated in step a) comprises at least 30% by weight, preferably at least 35% by weight alkaline earth metal hydroxide, based on the total amount of alkaline earth metal carbonate and alkaline earth metal hydroxide.

Furthermore, the mixture to be granulated in step a) may also comprise alkaline earth metal oxide.

According to a further preferred embodiment of the method according to the invention, alkaline earth metal carbonate with a particle size group of 10 to 125 μm and/or alkaline earth metal hydroxide with a particle size group of 10 to 125 μm and/or alkaline earth metal oxide with a particle size group of 10 to 125 μm is used for the mixture to be granulated in step a). By using starting materials with such a particle size group, granules can be prepared particularly well.

The granulation in step a) can be carried out in various ways known to those skilled in the art, for example in a granulating machine with a granulating plate or a granulating drum.

According to a preferred embodiment of the method, the granules of the granulate prepared in step a) have a particle size of 0.5 to 5.0 mm, preferably 0.5 to 4 mm, more preferably 0.7 to 3 mm.

According to a further preferred embodiment of the invention, the granules produced according to step a) are a hydrated lime-bound material.

The calcium oxide content in the granules obtained according to step a) may be in the range of 10 to 50% by weight calcium oxide, based on the total weight of the granules.

Preferably, the gas containing carbon dioxide with which the granules in step b) and/or in step d) are brought into contact is a gas comprising at least 30% by volume, in particular at least 40% by volume, carbon dioxide.

In order to obtain a sufficient reaction rate and a good equilibrium position for the recarbonation, it is advantageous if, in at least one of steps b) and d), the gas containing carbon dioxide is brought to a temperature of 160° C. or more, preferably from 180 to 220° C., and/or the granules are brought to about 60° C. or more, preferably from 80 to 120° C.

It has proven to be particularly favorable for the recarbonation in at least one of steps b) and d) to bring the gas containing carbon dioxide to a temperature of 160° C. or more. Practical experiments have shown that, for the recarbonation in step b), a recarbonation period of 2 to 6 hours, in particular 3 to 5.5 hours, may be sufficient. In this step, the calcium oxide content of the granules may be reduced to values from 0.5 to 3% by weight, in particular from 0.8 to 1.5% by weight.

Preferably, the second recarbonation step is carried out under substantially the same conditions as the first recarbonation step.

In order to obtain the material according to the invention having a low calcium oxide content, the second recarbonation in step d) is continued until the calcium oxide content in the granulate is 0.3% by weight or less. For example, recarbonation periods from half an hour to 5 hours, preferably from 1 hour to 4 hours, have proven to be favorable for the second recarbonation step.

In step c), sieving to a particle size group of 0.1 to 1.8 mm is carried out. According to a preferred embodiment of the invention, sieving is carried out so that granules are obtained with a particle size group of 0.2 to 1.7 mm, in particular 0.5 to 1.6 mm and more preferably 0.71 to 1.25 mm.

The invention further comprises materials which are obtainable with the method according to the invention.

As explained above, the material prepared by the method according to the invention is exceptionally suitable for deacidification, filtration and/or hardening of liquids, particularly water. It is particularly advantageous, that, with its application even with novel filter masses over-alkalization during the start-up phase can be avoided.

Owing to its fine particle size, the material is also exceptionally suitable for treating liquids, particularly water, which contain iron and/or manganese impurities.

The invention is elucidated in more detail below by means of three examples.

### EXAMPLE 1

### Preparation of the Material According to the Invention in the Form of Granules

60% by weight limestone powder and 40% by weight white hydrated lime are homogeneously mixed. The mixture is fed via a metering device to a granulating machine. After addition of water in proportions by mass of about 10 to 15% by weight, based on the total amount of limestone powder, white hydrated lime and water, granules are produced. The particle size can be arbitrarily selected, for example from 0.5 to 5 mm. Preference is given to a particle size of ca. 1 to 3 mm. The granulate thus prepared is placed in a drum reactor and recarbonatated by introducing gas containing carbon dioxide heated to about 180° C. having a proportion by volume of carbon dioxide >30% by volume.

The free calcium oxide present in the granulate is converted to calcium carbonate by carbon dioxide. In this case, the granulate is heated to a temperature of 110° C. after an appropriate recarbonation period. The recarbonation is continued until a calcium oxide content of about 2% by weight is present in the granulate. After completion of the reaction, the batch is fed to a filter system and sieved to a particle size group of 0.5 to 1.6 mm.

The free calcium oxide present in the granulate is converted to calcium carbonate by carbon dioxide. In this case, the granulate is heated to a temperature of 110° C. after an appropriate recarbonation period. The recarbonation is continued until a calcium oxide content of about 2% by weight is present in the granulate. After completion of the reaction, the batch is fed to a filter system and sieved to a particle size group of 0.5 to 1.6 mm.

Subsequently, the granules are heated to a temperature of 110° C. in a second recarbonation step. The recarbonation is continued for 3 hours until a calcium oxide content of only 0.3% by weight or less is present.

### EXAMPLE 2

### Comparison Between the Inventive Granules According to Example 1 and Granules According to DE 195 03 913 A1

In the following table characteristic parameters of the inventive granules according to Example 1 and of granules produced according to the method described on page 2, in the example of DE 195 03 913 A1 are compared.

| | | Granules | |
|---|---|---|---|
| | | according to page | Inventive granules |
| | | 2, example of DE | according to |
| | | 195 03 913 A1 | Example 1 |
| Chemical | Calcium oxide CaO | ca. 1.0% by weight | 0.3% by weight |
| composition | Calcium carbonate | ca. 97.5% by | ca. 98.0% by weight |
| | CaCO₃ | weight | |
| | Magnesium | ca. 0.8% by weight | ca. 1.2% by weight |
| | carbonate MgCO₃ | | |
| | Fe₂O₃ and Al₂O₃ | ca. 0.3% by weight | ca. 0.2% by weight |
| | Silica SiO₂ | ca. 0.4% by weight | ca. 0.3% by weight |
| Particle size | Particle size group | Particle size I: 0.5-3.15 mm | 0.5-1.6 mm |
| | (DIN EN 12902) | | |
| | Bulk density | Particle size I: ca. | 1.1-1.3 t/m³ |
| | (storage density) | 1.25-1.30 t/m³ | |
| Consumption | per g CO₂ (bound) | ca. 3.5 g | ca. 2.5 g |
| (including flushing | | | |
| losses) | | | |
| Hardness | per g/m³ CO₂ | ca. 0.128 °dH | ca. 0.128 °dH |
| | (bound) | | |
| Amounts used: empty | at 20 minutes | 330 kg/m³ | 270 kg/m³ |
| bed contact time | contact time | | |
| Filter material layers | with open filters | 1000-2000 mm | 1000-2000 mm |
| | with closed filters | 1500-3000 mm | 1500-3000 mm |
| Filtration rate | with open filters | up to 15 m/h | up to 15 m/h |
| | with closed filters | up to 30 m/h | up to 30 m/h |
| Physical parameters | Bulk density | 1.1-1.3 g/cm³ | 1.1-1.2 g/cm³ |
| | Specific surface area | 3.4 m²/g | 5.8 m²/g |
| | (BET/ISO 9277) | | |
| | Apparent density | 2.1 cm³/g | 2.1 cm³/g |
| | Strength (weight | 6.4 kg | 6.4 kg |
| | loading to | | |
| | destruction) | | |
| Turbidity | NTU (DIN EN ISO | 0.1-0.3 | 0.07-0.2 |
| | 7027 (C2) 2000-4) | | |
| Filtration effect | water having an Fe | 0.2 mg/dm³ | 0.01 mg/dm³ |
| | content of 0.2 mg/dm³ | | |

As can be seen in the table, the inventive granules according to Example 1 are characterized by a lower calcium oxide content and a larger specific surface area as compared with the known filter material produced according to page 2 in the example of DE 195 03 913 A1.

Using the inventive material according to Example 1, it is further shown that improved consumption values per gram of bound CO2 and at the same time reduced turbidity values can be achieved. The improved filtration effect with waters containing iron is also readily seen.

### EXAMPLE 3

### Use of Inventive Granules According to Example 1 for Deacidification of Water by Filtration

The material in the form of granules prepared in Example 1 as a chemically reactive filter material in open and closed fixed bed filters according to standard DIN 19 605 is used in the following application fields:
deacidification and filtration of spring, well and/or surface waters
deacidification and filtration in combination with deferrizing and demanganizing
hardening of distillate and permeate for use thereof as drinking water

In these applications, it can be shown that even when a large quantity is introduced into the filter during the start-up phase, no over-alkalization takes place.

The inventive material according to Example 1 proves to be a highly reactive filter material with which the requirements of standard DIN EN 1018 type A of the drinking water regulation and standard DIN 2000 can be met. After complete incorporation and continuous operation, no substances are released to the water which could lead to exceeding the limits of the drinking water regulation.

Moreover, the inventive material according to Example 1 ensures a safe, low-maintenance and economically favorable operation due to its high reactivity, stable particle structure and high chemical and microbiological degree of purity.

1-24. (canceled)

25. A method for deacidifying, filtering, or hardening a liquid comprising contacting the liquid with a material for deacidification, filtration and/or hardening liquids, comprising at least 97% by weight alkaline earth metal carbonates, wherein the free calcium oxide content of the material, determined according to the DIN EN 12485:2010-08 standard, is 0.3% by weight or less, and the particle size group of the material, determined according to the DIN EN 12902:2005-02 standard, is from 0.5 to 1.6 mm, wherein the oversized and undersized content of the particle size group of the material is 10 wt % or less, based on the total weight of the material with the particle size group, wherein the material is in the form of granules in the liquid.

26. The method of claim 25, wherein the liquid comprises impurities of iron, magnesium, or both.

27. The method of claim 26, wherein the liquid is water.

28. The method of claim 25, wherein the specific surface area of the granules is at least 3.5 m²/g as determined according to the BET method ISO 9277 standard.

29. The method of claim 25, wherein the specific surface area of the granules is 3.5-5.5 m²/g.

30. The method of claim 25, wherein the specific surface area of the granules is at least 4-5 m²/g.

31. The method of claim 25, wherein the specific surface area of the granules is 5.8 m²/g.
